(19) United States
(12) Patent Application Publication
(10) Pub. No.: US 2011/0191133 A1
(43) Pub. Date: Aug. 4, 2011

(54) SYSTEM AND METHOD FOR SALES MANAGEMENT

(75) Inventors: Mehul Sanghavi, Mumbai (IN); Padma Kumar, Bangalore (IN); Sunil Jose Gregory, Thrissur (IN)

(73) Assignee: INFOSYS TECHNOLOGIES LIMITED, Bangalore (IN)

(21) Appl. No.: 12/813,905

(22) Filed: Jun. 11, 2010

(30) Foreign Application Priority Data
Feb. 2, 2010 (IN) 252/CHE/2010

(51) Int. Cl. G06Q 10/00

(52) U.S. Cl. 705/7.12

(57) ABSTRACT

A method and system is provided to manage sales and contracts effectively. The system includes analysis module to analyze sourceability of a component of the functional unit, a first processing to identify work requisites, a segmenting module to atomize work requisites, and a second processing module to group the atomized work requisite, and allocate the grouped work requisite to a resource. Additionally, a module is adapted to parameterize the component of the functional unit. The present system and method assist in improving effectiveness and efficiency of business environment of the enterprise.

### CROSS-REFERENCE TO RELATED APPLICATIONS

The present application claims the benefit of and priority to Indian Patent Application Serial No. 252/CHE/2010, filed Feb. 2, 2010, the disclosure of which is hereby incorporated herein by reference.

### BACKGROUND OF THE INVENTION

The present technique relates in general to a system and a method for managing sales and contract effectiveness. More particularly, the present technique relates to a system and a method for identifying work requisites to be executed and selecting matching resource to perform it.

An enterprise normally comprises various functional units. Each unit of an enterprise is expected to execute certain activities which are aligned with objectives of the enterprise. Over the years, new methods and systems have been developed to improve efficiency of each unit. For example, a customer relationship management (CRM) program incorporates interaction between the enterprise and its customers. Various activities, such as handling customer phone calls, email, conducting survey, and monitoring customer satisfaction are performed to achieve successful implementation of CRM programs.

To perform each activity, a resource should encompass specialized skill sets. However, in one circumstance, a resource might not be available at a specified location. In yet another circumstance, economically it is difficult to maintain a resource at a particular location because of high resource cost involved. The situation turns out to be more complex for a sizeable enterprise where multiple and complex activities are performed. To run an enterprise successfully, it is essential to make various activities of the enterprise competitive against the competitors in the area of business. Many a time, the enterprises are not in a state to assess effectiveness and efficiency or even many a time, certain activities need not be performed within the enterprise, which is not noticed. This results into a loss in profitability. Also, the skill sets available with the enterprise are not utilized appropriately. When activities of the enterprise are not utilized appropriately, it eventually concludes into loss of business or losing advantage over competitors or loss in profitability or combinations thereof.

Therefore, a system and method are required where various activities performed by the enterprise are assessed, following which various options are derived to achieve the objectives of the organization efficiently and effectively.

### BRIEF SUMMARY OF THE INVENTION

The present technique is directed to a system and a method for managing and maximizing efficiency and profitability of a unit of an enterprise. According to one embodiment of the present technique, a system for sales and contract management is provided. The system includes at least one analysis module. The analysis module is configured to identify various components of a unit of an enterprise wherein an enterprise may comprise one or more than one units and a unit may comprise one or more than one components. Additionally, the analysis module is enabled to parameterize various components of the units. The parameterization of components facilitates selecting work requisites that should be processed to segment and subsequently grouping the work requisites. The segmentation and grouping of segmented work requisites assists in deciding whether the grouped work requisites are to be performed internally or externally.

Further, a first processing module is adapted to identify the work requisites that are required to be performed. The work requisites can be of an independent work type or a dependent work type. According to yet another embodiment of the present technique, the identified work requisites are atomized using a segmenting module. The segmenting module is enabled to atomize the identified independent or dependent work requisites to its granular level. Subsequently, a second processing unit is adapted to group the atomized work requisites selectively, followed by allocating the grouped work to a resource having matching skills.

According to yet another embodiment of the present technique, a method for managing sales and contracts of an enterprise is provided. According to one embodiment of the present technique, the method includes analyzing sourceability of the components of a functional unit of the enterprise. Various components of the functional unit are identified. Each component is provided a value while parameterizing the components. The parameterization contributes in selection of work requisites required to be performed. Following the identification of work requisites, the work requisites are segmented into atomized work requisites. The atomized work requisites are granular work requisites. Subsequently, the atomized work requisites are grouped and requirement analysis is performed. The requirement analysis includes, but is not limited to, analyzing resource requirement and technology environment requirement. The resource requirement evaluation includes analyzing resource roles & responsibilities being conferred on a professional or a group of professionals, essential qualifications, technical aptitude, experience, cost to retain the resource, and the like. The technology environment requirement analysis includes, but is not limited to, analyzing hardware, software, cost to maintain them, and the like. Subsequently, the work is allocated to a professional or a group of professionals available internally or externally.

### BRIEF DESCRIPTION OF THE DRAWINGS

These and other features, aspects, and advantages of the present technique will become better understood when the following detailed description is read with reference to the accompanying drawings in which like characters represent like parts throughout the drawings, wherein:

FIG. 1 illustrates a sales and contract management system 100 that defines sourceability of a job in accordance with one embodiment of the present technique;

FIG. 2 illustrates an example flowchart for job allocation according to one embodiment of the present technique;

FIG. 3 illustrates an example flowchart for work atomization and allocation according to one embodiment of the present technique; and

FIG. 4 is a system illustrating a generalized computer network arrangement, in one embodiment of the present technique.

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the systems and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As will be appreciated by people skilled in the art, to best understand the present invention, it is important to be familiar with the definitions of terms being used:

“Server” includes a server application or applications, including an application server, a web server, and other necessary hardware or software components, to facilitate secure access to the server.

“Sourceability” defines activities that can be performed by resources available at multiple sites.

“Component” describes the type of jobs being performed by a selected resource.

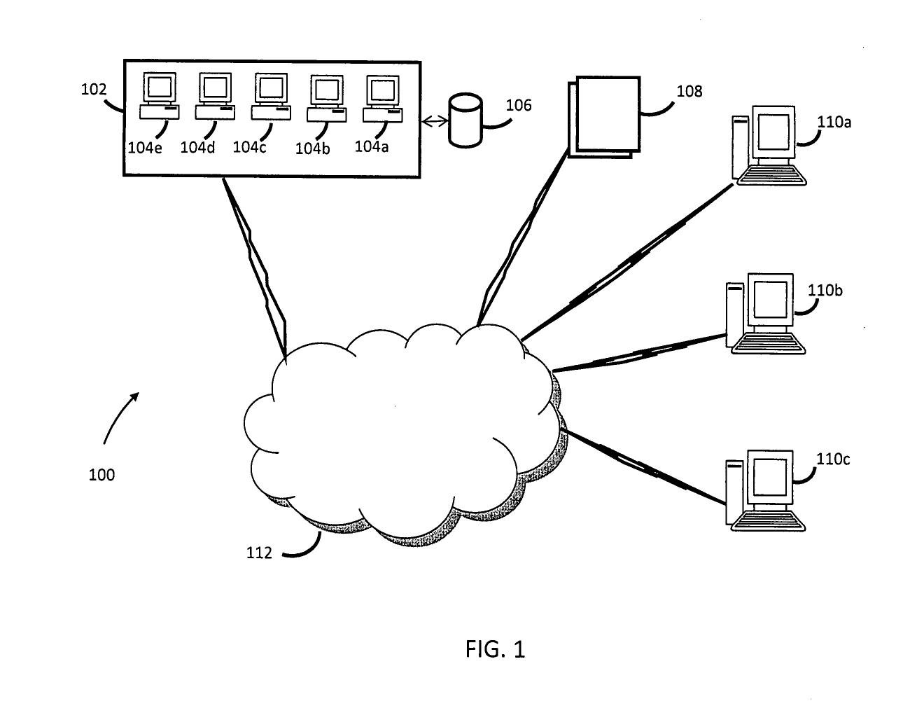

Referring to figures, FIG. 1 illustrates a sales and contract management system 100 that defines sourceability of a job in accordance with one embodiment of the present technique. As illustrated, sales and contract management system 100 includes an enterprise machine 102, a database 106 storing various information relevant to the enterprise machine 102, a server 108, one or more resource machines (110a, 110b, 110c) located at one or multiple geographic locations, and a network 112. Further, the enterprise machine 102 includes one or more processing machines, for instance 104a, 104b, 104c, 104d, and 104e. These processing machines 104a, 104b, 104c, 104d, and 104e are enabled to execute one or more activities designated therein. The server 108 is coupled to the network 112 and the database 106 of sales and contract management system 100. The server 108 is a processing device comprising hardware and softwares, as apparent to those skilled in the relevant art. The server 108 performs various activities as instructed and directed by any of the processing machines of the enterprise machine 102 wherein the said machines are configured to interact with server 108 through the network 112.

According to one embodiment of the present technique, the processing machines 104a, 104b, 104c, 104d, and 104e are enabled to identify various components of a functional unit of the enterprise, identify types of work requisites to be performed to achieve objectives of the component, perform the process of atomizing the work requisites, perform the process of grouping the atomized work and allocate the grouped work to one or more resource machines 110a, 110b, 110c configured to perform the allocated work. Additionally, any of the processing machines 104a, 104b, 104c, 104d, and 104e may also be enabled to parameterize the components of the functional unit. The parameterization of the components enables the enterprise to decide whether related activities of the components should be performed internally or externally. Thus, it provides an opportunity to decide whether the work requisites need to be performed internally i.e., within the enterprise or externally i.e., by selected external agencies. As used herein, “internally or internal” defines within the said enterprise and “externally or external” defines outside the said enterprise.

The database 106 is integrated with processing machines of the enterprise machine 102. The database 106 stores various information processed by the processing machines of the enterprise machine 102, for instance, information related to functional units of the enterprise, information related to various components of the units or the work activities performed for each component, and so forth. The functional unit is a designated unit of the enterprise designed to perform required work requisites aligned with objectives of the enterprise. For instance, the sales and contract management unit of the enterprise performs various work requisites related to bidding for a contract, abandoning a bid, achieving sales targets, and the like. The database 106 is also configured to collect and store information about the atomized work requisites, grouped atomized work, and the like. Additionally, the database 106 also stores information about the resource and location of the resource wherein the resources provided at various locations comprise diverse skill sets and an ability to perform designated work requisites.

The network 112 of the sales and contract management system 100 is enabled to facilitate communication between the processing machines of the enterprise machine 102, server 108, and resource machines 110a-110c. The network 112 is also enabled to provide communication for other hardware and communication machines, though not shown in FIG. 1. The network 112 includes, but is not limited to, the Internet, a local area network (LAN), a wide area network (WAN), and the like.

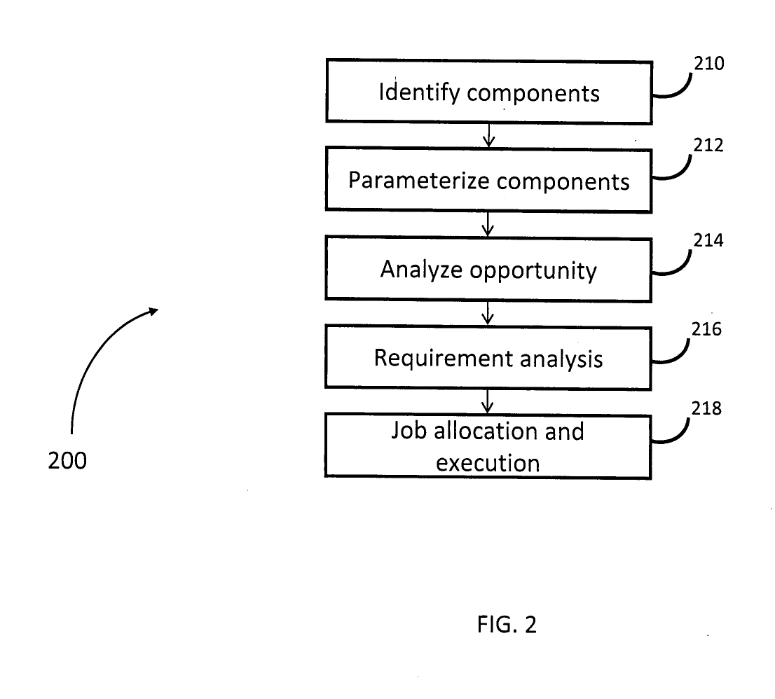

FIG. 2 illustrates an example flowchart for job allocation according to one embodiment of the present technique. The method includes identifying various components of a functional unit of the enterprise. For example, for a sales and contract management unit, which is one of the functional units of the enterprise, various relevant components are identified. The components are the work types performed by an individual professional or a group of professionals of the enterprise. For example, cash management of the enterprise is performed by an individual professional or a group of professionals of the enterprise. The work types of components are required to perform one or more work requisites to achieve the completion of the task. Thereof, a component is identified as represented by block 210.

Following the identification of one or more components of the functional unit, parameterization of the component is initiated. As described in the present technique, the parameterization of the components assists in generating an opportunity to identify and select the work requisites that are being performed either internally or externally or in collaboration.

According to one embodiment of the present technique, the method of parameterization of the component includes providing a value to one or more work requisites. Based on Business Risk, Data sensitivity, Project Commercials, Experience, Technology complexity, Tools Offshoreability & Onsite Effots, Manageability, Client Specific Knowledge, Strategic Intent, more specifically, providing a value for one or more work requisites. For example, let us consider a typical sales cycle. The starting point of the sales cycle is “Generating Leads”. Post analysis, this can be divided into three major chunks of work which is Understand Customers' environment, Explore & Develop opportunities with Customer and Initial Assessment of Bid. A parameterization is done for the work request “Understand Customer' environment” on the above mentioned dimensions. For example “Business Risk” is assessed on the basis of number of users affected expressed as % of total users, Impact that the process will have on individual users and interdependence on other business processes. Using an algorithm, a specific number is assigned for this particular dimension. The process is repeated for the other dimensions mentioned and as displayed in Table I.

TABLE I

| | Generate Leads | | |
|---|---|---|---|
| | | Explore & | |
| | | Develop | |
| | Understand | opportunities | Initial |
| | Customers' | with | Assessment |
| | environment | Customer | of Bid |
| Business Risk | 2.4 | 3.3 | 8 |
| Data sensitivity | 0.9 | 0.9 | 0.9 |
| Project Commercials | 2.1 | 2.1 | 3.3 |
| Experience | 1.5 | 1.5 | 3 |
| Technology complexity | 0.9 | 0.9 | 3 |
| Tools Offshoreability & | 3.7 | 3.7 | 7 |
| Onsite Efforts | | | |
| Manageability | 6.3 | 6.3 | 21 |
| Client Specific Knowledge | 1.2 | 1.2 | 3.2 |
| Strategic Intent | 2.7 | 2.7 | 6.6 |
| Weighted Totals | 21.7 | 22.6 | 56 |
| Weighted Average | 32% | 34% | 84% |

The weighted average provides a parametric score. Subsequently, based on the parametric score, an opportunity is analyzed as represented by block 212. Based on the parametric score, the enterprise can decide which work requisites should be performed internally and which work requisites should be performed externally.

According to one embodiment of the present technique, the work requisite may be an independent work activity that has no dependencies on any other work activities. Alternatively, the work requisite may be a dependent work activity that is coupled with any other independent work activity or a dependent work activity, though not displayed in FIG. 2.

According to another embodiment of the present technique, the work activities of each component of the units are segmented into a granular level. Subsequently, the atomized work requisites are analyzed and a decision is taken on whether any of the atomized work requisites can be grouped. The atomizing of the work requisites and subsequent grouping of the atomized work requisites provides an opportunity to create one or more new groups of work requisites. The new groups of the work requisites are essentially consistent with the objectives of the enterprise and eliminate superfluous work requisites. Thereafter, the requirement analysis of the resource, the technology environment, and the like is performed. The requirement analysis assists in anticipating the resource, the technology environment, and the like are required to execute the grouped work requisites as represented by block 216. For example, the assessment of requirements analysis for the resource, wherein the resource is a human resource, includes, but is not limited to, types of work requisites anticipated to be performed, technical or functional aptitude of the resource, cost for retaining the resource, availability of the specific talent in large numbers in the geography for easy ramp up and ramp downs, specific possible career paths available for the resource with skills, aptitudes and the like. Similarly, the technology environment requirement is also assessed. The technology environment analysis assists in anticipating the type of hardware, software, cost incurred in maintenance of the technology environment, learning curve for the specific technology, availability of similar technology, availability of it and the like therein. Subsequently, based on requirement analysis, the grouped work requisites are allocated to one or more resource as represented by block 218. The resource can be an internal resource or an external resource. If the resource and the technology environment are available within the enterprise and the financial and technology environment, as performed during requirement analysis 216, favor internal execution of grouped work, the grouped work is performed internally. Otherwise, the grouped work is executed externally.

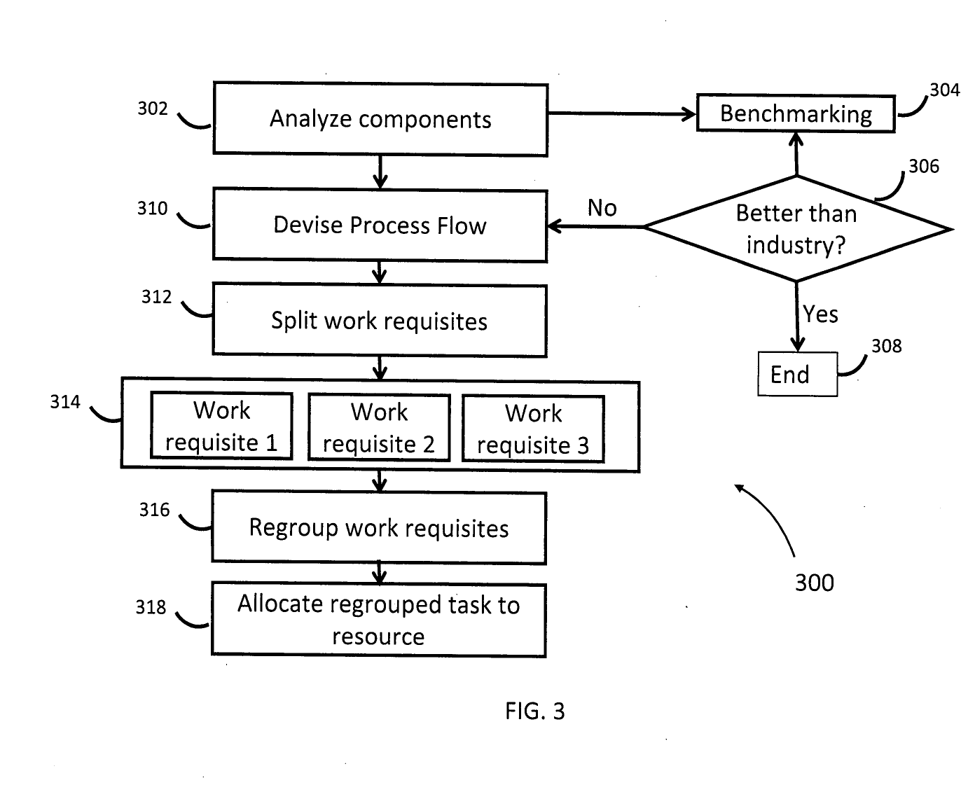

FIG. 3 illustrates an example method for work atomization and allocation according to one embodiment of the present technique. The component of a functional unit of the enterprise, for example sales and contract, is evaluated at block 302. The evaluation includes analyzing sales support resource allocation, bidding for a project, possibilities of wining the bid and revenue calculations for a stipulated period, for example, one year. The revenue calculations include, but are not limited to, prior sales performance, revenue loss, and expenditure related to resource allocation, revenue productivity, and the like. The total revenue loss or profit is analyzed with respect to the prevailing industry in the domain. Thus, a benchmarking of sales and contract against the industry is created and analyzed as represented by block 304 and block 306. If the benchmarking results are better than those set by the industry, the subsequent process ceases herein as represented by block 308, else the process proceeds to devising the process flow at block 310 for subsequent activities.

The process flow at block 310 is devised wherein the process flow defines the subsequent activities to improve sales and contract efficiency and effectiveness and to achieve the benchmarked value thereof. The devising of process flow includes, but is not limited to, work requisites, resource requirement analysis, work restructuring, performance measures, work classifications, and the like. The work requisites are segmented as represented by block 312. The segmentation of work requisite results in atomized work requisites such as work requisites 1, work requisite 2, and work requisite 3 are represented in block 314. These atomized work requisites are specified work activities. For example ‘Proposal Management’ which is a part of sales is broken down into project Management of Bid Team, develop Bid document, creation of technical solution, creation of service design, pricing and including terms and conditions. The atomized work requisites were further grouped based on their global sourceability, potential of the grouped job requisites to be organized into a career stream, definition of work, roles and responsibilities and associated authority, organization chart with specific touch points. Now the Proposal management is grouped into technical solution, bid management, pricing, proposal design, legal and finance and specific roles and career hierarchy is defined in the grouped work requisites. It should be noted that there may be possibilities where a few work requisites depend on one or more independent work activities, that is, dependent work requisites are linked to independent work requisites. These dependent work requisites are performed to achieve an independent work requisite. While atomizing the work requisites, the dependent work requisites are reallocated with independent work requisites.

According to one embodiment of the present technique, the atomized work requisites are grouped as represented by block 316. The -grouping of atomized work requisites results into core work activity. While grouping the atomized work requisites, the dependent work requisites are grouped in a similar group along with the independent work requisites. To perform the work activities related to a core work activity, a requirement analysis is initiated which is described in FIG. 2.

Thereafter, the work requisites related to the core work activity are allocated to one or more resources wherein the resource may be an internal employee or an external professional or a group of professionals or an enterprise.

### Exemplary Computing Environment

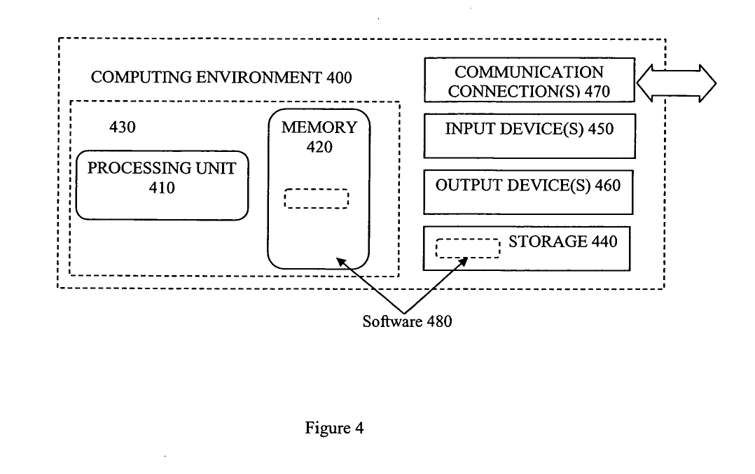

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

1. A system for sales and contract management, comprising:
an analysis module adapted to analyze sourceability of a functional unit of an enterprise by identifying at least one component of the functional unit;
a first processing module adapted to identify one or more work requisites to be performed, wherein the one or more work requisites are based on the analyzed sourceability for the functional unit of the enterprise;
a segmenting module adapted to atomize the one or more work requisites to be performed; and
a second processing module adapted to:
group the atomized work requisites; and
allocate the grouped work requisites to at least one resource.

2. The system of claim 1, wherein the analysis module parameterizes the components of the unit of the enterprise.

3. The system of claim 2, wherein the analysis module identifies at least one work opportunity based on parameterization of the components.

4. The system of claim 1, wherein the one or more work requisites are independent.

5. The system of claim 1, wherein the one or more work requisites are dependent.

6. The system of claim 1, wherein the second processing module defines the grouped atomized work requisites as at least one of independent and dependent.

7. The system of claim 1, wherein the second processing module analyzes at least one of resource requirements and technology environment requirements.

8. The system of claim 1, further comprising a skills identification module to identify skill sets required to execute the grouped atomized work requisites.

9. The system of claim 8, wherein the skills identification module identifies at least one resource having the required skill sets.

10. The system of claim 1, further comprising a memory module adapted to store the one or more work requisites.

11. A computer implemented method for sales and contract management, comprising:
analyzing sourceability of a unit of an enterprise by identifying at least one component of the functional unit;
identifying one or more work requisites to be performed, wherein the one or more work requisites are based on the analyzed sourceability for the functional unit of the enterprise;
atomizing the one or more work requisites to be performed; and
grouping the atomized work requisites and allocating the grouped work requisites to at least one resource.

12. The method of claim 11, further comprising parameterizing the components of the unit of the enterprise.

13. The method of claim 12, further comprising identifying at least one work opportunity based on parameterization of the components.

14. The method of claim 11, wherein the one or more work requisites are independent.

15. The method of claim 11, wherein the one or more work requisites are dependent.

16. The method of claim 11, wherein the atomized work requisites are grouped as at least one of independent and dependent.

17. The method of claim 11, further comprising analyzing at least one of resource requirements and technology environment requirements required to execute the grouped atomized work requisites.

18. The method of claim 11, further comprising identifying skill sets required to execute the grouped atomized work requisites.

19. The method of claim 18, wherein the skills identification identifies at least one resource having the required skill sets.

20. The method of claim 11, further comprising storing the work requisites at a memory hardware.

21. A computer program product comprising a computer usable medium having a computer readable program code embodied therein for sales and contract management, comprising:
a program code adapted for analyzing sourceability of a functional unit of an enterprise by identifying at least one component of the functional unit;
a program code adapted for identifying one or more work requisites to be performed wherein the one or more work requisites are based on the analyzed sourceability for the unit of the enterprise;
a program code adapted for atomizing the one or more work requisites to be performed; and
a program code adapted for grouping the atomized work requisites and allocating the grouped work requisites to at least one resource.

22. The computer program product of claim 21, wherein a program code is adapted for parameterizing the components of the unit of the enterprise.

23. The computer program product of claim 22, wherein a program code is adapted for identifying at least one work opportunity based on parameterization of the components.

24. The computer program product of claim 21, wherein a program code is adapted for identifying the one or more work requisites are independent

25. The computer program product of claim 21, wherein a program code is adapted for identifying one or more work requisites are dependent.

26. The computer program product of claim 21, wherein a program code is adapted for grouping the atomized work requisites as at least one of independent and dependent.

27. The computer program product of claim 21, further comprising analyzing at least one of resource requirements and technology environment requirements are required to execute the grouped atomized work requisites.

28. The computer program product of claim 21, further comprising a program code is adapted for identifying skill sets required to execute the grouped atomized work requisites.

29. The computer program product of claim 28, wherein a program code is adapted for skills identification to identify at least one resource satisfying the identified skill sets.

30. The computer program product of claim 21, further comprising a program code is adapted for storing the work requisites at memory hardware.
